(19) United States
(12) Patent Application Publication
(10) Pub. No.: US 2016/0098655 A1
(43) Pub. Date: Apr. 7, 2016

(54) INTERACTIVE BUSINESS LIFECYCLE MANAGEMENT SYSTEM

(71) Applicants: Raghu Varadan, San Francisco, CA (US); Ashish John, San Francisco, CA (US); Nagendra Pattavardhanam, San Francisco, CA (US); Rajesh Venkatasubbu, San Francisco, CA (US)

(72) Inventors: Raghu Varadan, San Francisco, CA (US); Ashish John, San Francisco, CA (US); Nagendra Pattavardhanam, San Francisco, CA (US); Rajesh Venkatasubbu, San Francisco, CA (US)

(21) Appl. No.: 14/873,075

(22) Filed: Oct. 1, 2015

Related U.S. Application Data
(60) Provisional application No. 62/058,379, filed on Oct. 1, 2014.

(51) Int. Cl. G06Q 10/06

(52) U.S. Cl. CPC G06Q 10/0637; G06Q 10/0635

(57) ABSTRACT

An interactive business lifecycle management system is disclosed which provides intuitive views of business programs, program performance, operations status, and compliance status. The interactive business lifecycle management system provides near real-time status, process analytics, business portfolio management, compliance and governance functions over business operations, and delivers program lifecycle management functions complete with comprehensive business program analysis capabilities and governance program compliance analysis. In this way, the interactive business lifecycle management system enables business leaders to perform business operations while satisfying governance compliance objectives.

### CLAIM OF BENEFIT TO PRIOR APPLICATION

This application claims benefit to U.S. Provisional Patent Application 62/058,379, entitled “A computer application software that relates to the interactive lifecycle management of business programs providing near real-time status, process analytics, business portfolio management, compliance and governance functions over business operations,” filed Oct. 1, 2014. The U.S. Provisional Patent Application 62/058,379 is incorporated herein by reference.

### BACKGROUND

Embodiments of the invention described in this specification relate generally to business management systems, and more particularly, to an interactive business lifecycle management system that provides near real-time status, process analytics, business portfolio management, compliance and governance functions over business operations.

Organizations are facing growing regulatory and industry standards requirements, shifting business imperatives, changing customer needs, fluid market conditions, and increasing risks to their operations. This situation has caused organizations to build and rely upon an ecosystem of business partners to provide specialized services as well as building their own flexible and responsive business processes to realize efficiencies.

Increased global competition and the combination of market forces and a dynamic business environment demand a new approach to business governance, risk management and attaining compliance. Overall, the challenging and globally competitive economic climate necessitates transforming business operations and requires organizations to exercise greater control over business operations, mitigate business risks, rely on an ecosystem of partners, and adapt business processes to be more flexible, efficient, and responsive to market needs.

There are business process modeling tools and products available today that allow business processes to be modeled. These existing products provide a static depiction of business processes and illustrate the workflow that constitutes the process. These products render graphical representations of the workflows that comprise a specific business process.

The biggest deficiency associated with existing methods is the lack of providing key business metrics for business processes. The existing static graphical business process rendering methods do not contain real-time business process measures or intelligent guidance capabilities based on the current state of the business process.

Therefore, what is needed is an interactive and intuitive solution that fosters collaboration and communication, assists with productivity improvements, provides guidance on appropriate actions to mitigate program risks, all in a single and integrated solution which provides business leaders visibility into business operations and processes, enable business leaders to identify and understand business risks, and to empower business leaders in ways that allow them to monitor key business metrics, including critical information needed to mitigate potential risks and to take proactive measures.

### BRIEF DESCRIPTION

Some embodiments of the invention include a novel interactive business lifecycle management system. In some embodiments, the interactive business lifecycle management system provides intuitive views of business programs, program performance, operations status, and compliance status. In some embodiments, the interactive business lifecycle management system (i) provides near real-time status, process analytics, business portfolio management, compliance and governance functions over business operations, and (ii) delivers program lifecycle management functions complete with comprehensive business program analysis capabilities and governance program compliance analysis. In this way, the interactive business lifecycle management system enables business leaders to perform business operations while satisfying governance compliance objectives.

In some embodiments, the interactive business lifecycle management system is implemented as a software application that provides a single business command center dashboard from which a user, such as a business leader, can interact with the interactive business lifecycle management system. In some embodiments, the interactive business lifecycle management system provides deterministic and adaptive intelligent guidance of business program activities based on the current context, status, issues, and risks. In further addressing the current context, status, issues, and risks, some embodiments of the interactive business lifecycle management system automatically associate business processes, related roles, and risks, and make recommendations, and provide impact analysis. In this way, the solutions provided by the interactive business lifecycle management system are not based on a static point-in-time reference, but rather, involves analysis of continually updated risk factors and their influence on various business entities and dependencies, which are fed back into a business planning framework of the interactive business lifecycle management system.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of several components of an interactive business lifecycle management system that provide intuitive views of business programs, program performance, operations status, and compliance status in some embodiments.

FIG. 2 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include an interactive business lifecycle management system. In some embodiments, the interactive business lifecycle management system provides intuitive views of business programs, program performance, operations status, and compliance status. In some embodiments, the interactive business lifecycle management system performs processes to provide near real-time status, process analytics, business portfolio management, compliance and governance functions over business operations, and deliver program lifecycle management functions complete with comprehensive business program analysis capabilities and governance program compliance analysis. In this way, the interactive business lifecycle management system enables business leaders to perform business operations while satisfying governance compliance objectives.

In this specification, there are several descriptions of systems, modules, components, methods, and processes that are performed by software running on one or more computing devices. However, it should be noted that for the purposes of the embodiments described in this specification, the word “method” is used interchangeably with the word “process”. Methods performed by the software are described, therefore, by reference to example processes that are performed by one or more modules, components, or aspects of the interactive business lifecycle management system when such modules, components, and aspects of the interactive business lifecycle management system are implemented as software applications or programs.

As stated above, organizations are facing growing regulatory and industry standards requirements, shifting business imperatives, changing customer needs, fluid market conditions, and increasing risks to their operations. This situation has caused organizations to build and rely upon an ecosystem of business partners to provide specialized services as well as building their own flexible and responsive business processes to realize efficiencies. Yet, the increased global competition and the combination of market forces and a dynamic business environment demand a new approach to business governance, risk management and attaining compliance. While there are business process modeling tools and products (or simply “products”) available today that allow business processes to be modeled, these existing products at best provide only static depictions of business processes and workflows, typically rendering graphical representations of the workflows that comprise a specific business process. However, today's challenging and globally competitive economic climate necessitates transforming business operations and requires organizations to exercise greater control over business operations, mitigate business risks, rely on an ecosystem of partners, and adapt business processes to be more flexible, efficient, and responsive to market needs.

In some embodiments, the interactive business lifecycle management system overcomes the shortfalls and deficiencies of the existing products. Specifically, the interactive business lifecycle management system provides visualization of key business metrics and risks and performs real-time analytics of dependencies, resources, and artifacts in ways that allow business leaders to avoid business risks and optimize resources across competing processes. In contrast, the existing products merely provide static representations of processes at a particular (static) point in time and do not interact with the actual business processes. As a result, the existing products cannot provide insights into business operations to determine if the processes are efficient or optimized or are in need of additional resources.

Additionally, current products do not provide any interactive metrics associated with business process performance to indicate whether any additional measures or actions need to be applied or whether the processes are vulnerable to risks. The interactive business lifecycle management system of the present disclosure, by contrast, offers visualization of key business metrics and risks, thereby providing a powerful aid to business leaders as they grapple with increasingly complex organizations, processes, and requirements. Moreover, the real-time analytics of dependencies, resources, and artifacts that are provided by the interactive business lifecycle management system is invaluable in assisting business leaders in avoiding business risks and optimizing resources across competing processes. Specifically, the combination of inference based matching, dynamic visualization of assets and controls, and integration with SIEM and governance products provides unique functionality that is coupled with analytics to deliver actionable recommendations to business leaders to mitigate business risks. This interactive and intuitive solution fosters collaboration and communication, assists with productivity improvements, provides guidance on appropriate actions to mitigate program risks, all in a single and integrated solution.

Pressures to existing economic and business realities, as noted above, means that organizations need to become more agile, flexible, and responsive while improving their competitive posture in the face of increasing uncertainty, increasing financial pressure, competition, and accelerating change. The interactive business lifecycle management system described in this specification addresses these needs and improves upon currently existing options by providing an effective governance program that enables the organization to respond to changing customer needs, business opportunities, business performance issues, and marketplace conditions. Given the economic and competitive realities that have evolved, an effective Governance, Risk, and Compliance (GRC) analytics management program is a necessity for businesses in order to transform their operations and remain competitive. An effective GRC analytics management program must provide visibility into business performance and lead to transformation of existing business processes into efficient, secure, and resilient processes that are capable of addressing the increasing environmental risks and improving competitive vitality.

In some embodiments, the management and governance functions of the interactive business lifecycle management system address the current needs of businesses by analyzing a variety of risks, providing early warning, and offering context-based recommendations on mitigating risks, improving performance, and optimizing usage of business resources. In this way, the interactive business lifecycle management system provides organizations with an innovative solution that provides business leaders with intuitive, at-a-glance views of program performance and operations status, delivers complete program lifecycle management functions and complete “what-if” analysis capability, and provides comprehensive governance program enablement that assists organizations in satisfying compliance objectives.

This is an improvement over existing business process modeling and governance methods, which do not perform real-time business risk impact analysis or automatically generate recommendations to mitigate risks. Additionally, the existing business process modeling and governance mechanisms lack the management and governance functions which are crucially associated with business processes and operations. In particular, such management and governance functions are critical for analyzing and proactively mitigating risks, and also for optimizing performance and usage of business resources. Existing IT GRC solutions focus on reporting IT incidents and events, not necessarily associated with business processes. In contrast, the interactive business lifecycle management system of the present disclosure enables and empowers business leaders to have visibility into business operations and processes, business risks, and monitor key business metrics, which provide business leaders with the critical information needed to mitigate potential risks and to take proactive measures in a single integrated solution. Furthermore, the interactive business lifecycle management system facilitates this far-reaching and timely view of business metrics by way of a business command center dashboard (which is implemented as a graphical user interface (GUI) dashboard in some embodiments).

Beyond the interface or presentation of the business command center dashboard, several components of the interactive business lifecycle management system perform processes that provide deterministic and adaptive intelligent guidance of program activities based on the current context, status, issues, and risks. It is the context driven assessment of business processes and identification of factors that drives the program planning and predictive analytics aspects of the interactive business lifecycle management system.

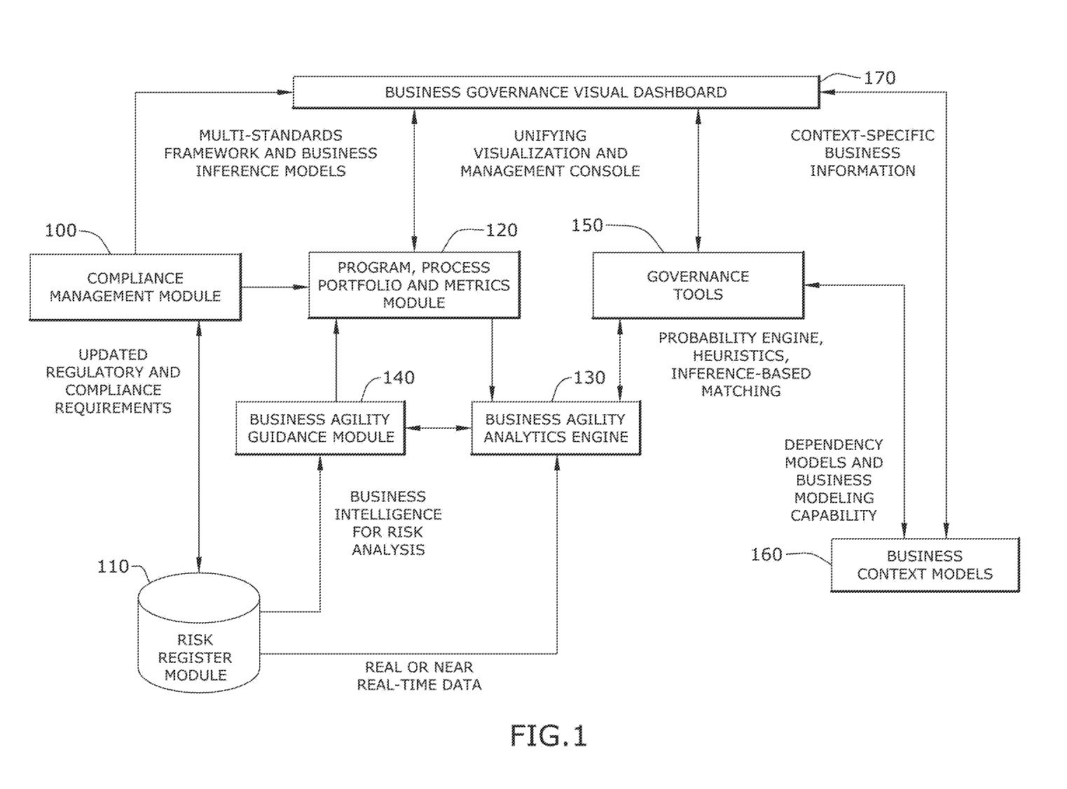

A plurality of components of an example interactive business lifecycle management system are described now. By way of example, FIG. 1 conceptually illustrates a block diagram of several components of an interactive business lifecycle management system that provide intuitive views of business programs, program performance, operations status, and compliance status. As shown in this figure, the interactive business lifecycle management system includes a plurality of components comprising a compliance management module 100, risk register data repository 110, a business metrics module 120, a business agility analytics engine 130, a business agility guidance module 140, a set of governance tools 150, a set of business context models 160, and a business governance visual dashboard 170. The interactive business lifecycle management system enables management and governance functions across different combinations of the components 100-170 to analyze a variety of risks, provide early warning, and offer context-based recommendations on mitigating risks, improving performance, and optimizing usage of business resources. This unique combination of integrated functions enables comprehensive views of business performance that enables actions to be taken to optimize operations and avoid business risks.

Specifically, the compliance management module 100 captures and displays user inputs, metrics, control definitions, stakeholder assignments. In some embodiments, the compliance management module 100 allows the user to perform comprehensive “what-if” analysis, scoring and dependency analysis, among numerous other analytics.

In some embodiments, the compliance management module 100 relies on the risk register data repository 110, which may be a single database or multiple databases (hereinafter referred to individually or collectively as “repository”), to get metadata on compliance metrics, heuristics on prior compliance transactions, probability analysis, extrapolation, and other metrics needed across the spectrum of compliance management processes. In some embodiments, the risk register data repository 110 also provides data for risk management and governance components.

The business metrics module 120 performs a set of functions with the metadata related to business programs, process portfolio, and the metrics. In other words, once the compliance management module 100 and the risk register data repository 110 are enabled, the business metrics module 120 captures the metadata related to portfolio and metrics that become essential for various analytics and process management for compliance action items. An interface to the business metrics module 120 is provided via the business governance visual dashboard 170 for the enablement and control of the compliance management module 100.

The business agility analytics engine 130 and the business agility guidance module 140 are two complimentary components of the interactive business lifecycle management system for compliance management, together providing the unique capability of business intelligence behind compliance controls, usage, and potential risks and outcomes. A knowledge-based component of the business agility guidance module 140 includes enterprise-specific and industry-wide information regarding potential risks, implementation best practices, standards, guidelines and all other related programmatic computable guidance.

A set of governance tools 150 includes a collection of GRC tools which allow a user to perform “what-if” analysis, governance benchmarking, risk analysis, forecasting, and other functions associated with one or more GRC tools. In the context of compliance management (directly or indirectly associated with the compliance management module 100), all of the set of governance tools 150 (e.g., GRC tools) are used as a part of the business governance visual dashboard 170 to provide a view of the compliance posture, risks involved, suggestive remediation plans and stakeholder maps among other GRC functions.

A set of business context models 160 (created through a modeler) are also included in the interactive business lifecycle management system. Specifically, the set of business context models 160 are fundamental to data feeds that are provided to the compliance management module 100, the business governance visual dashboard 170, the business agility analytics engine 130, the business agility guidance module 140, and other components of the interactive business lifecycle management system.

While the plurality of components 100-170 shown in FIG. 1 illustrate one example of the components of the interactive business lifecycle management system, the components function in a variety of interconnected and data-sharing manners. For instance, the interactive business lifecycle management system generally works by internal processes and operations of the compliance management module 100, including processes and operations based on one or more statistical business events inference models and multi-standard frameworks that provide visibility into the compliance posture of the organization against relevant regulations, standards, or organization objectives.

Similarly, the risk register data repository 110 includes statistical risk inference models, process metrics, and self-learning capabilities.

The business metrics module 120 provides intelligent and configurable metrics regarding risk and information asset portfolio. In addition, the business metrics module 120 captures business metadata including details about enterprise programs, processes, assets, and stakeholders.

The business agility analytics engine 130 provides multiple functions inclusive of a probability engine, heuristics, grammar constructs, inference-based matching, comprehensive “what-if” analysis, business assets centric analytics, and process based metrics learning.

The business agility guidance module 140 includes a patterns-based inference builder as well as a business impact drill-down capability.

The set of governance tools 150 provides statistical prioritization and dependency models, management tools and metrics, and analytics that provide insights and guidance over business processes, operations, and business programs.

The set of business context models 160 deliver business context models and controls relevant to the metrics, assets, business processes, and/or program management functions provided by a specific solution, such as i*DNA, which is a business solution that provides the ability to identify potential risks to sensitive business information assets that may affect business processes, operations, and competitiveness (i*DNA is described further below).

The business governance visual dashboard 170 unifies visualization and management in a single console that enables business performance visualization, business program lifecycle management, and business governance program enablement based on the integration process and platform metrics, process analytics, and grammar construct functions included within (or underlying) this component. The above components can be combined to perform many management and governance actions and tasks leading to one of the potential solutions (e.g., i*DNA, which is described further below) that can be delivered with this interactive lifecycle management of business programs providing near real-time status, process analytics, business portfolio management, compliance and governance functions over business operations.

The management and governance functions also analyze a variety of risks, provide early warning, and offer context-based recommendations on mitigating risks, improving performance, and optimizing usage of business resources. This unique combination of integrated functions enables comprehensive views of business performance that enables actions to be taken to optimize operations and avoid business risks.

To make the interactive business lifecycle management system of the present disclosure, specific domain expertise in GRC may be employed, in addition to GRC data repositories to develop (code or write code), build, and link or connect the aforementioned components in a system that is implemented as computer software. In addition, the interactive business lifecycle management system may utilize customer context data namely customers' GRC requirements and risks and issues in their current environment to reap the aforementioned benefits of the interactive business lifecycle management system.

A basic set of components, when built and connected together, provide a viable working interactive business lifecycle management system. The basic set of components of the interactive business lifecycle management system include the compliance management module 100, the risk register data repository 110, the business metrics module 120, the set of business context models 160, and the business governance visual dashboard 170.

Beyond this basic set of components 100-120 and 160-170, the other components, namely the business agility analytics engine 130, the business agility guidance module 140, and the set of governance tools 150, may be used in alternate embodiments of the interactive business lifecycle management system along with the basic set of components 100-120 and 160-170. In such alternate embodiments of the interactive business lifecycle management system, the business agility analytics engine 130, the business agility guidance module 140, and the set of governance tools 150 may be configured in ways that provide one or more of the aforementioned benefits or capabilities of the interactive business lifecycle management system.

In some embodiments, the interactive business lifecycle management system leverages one or more components or data of external systems. Specifically, the interactive business lifecycle management system may leverage one or more third party applications in order to add data, integrate an application programming interface (API), or utilize one or more special features of such third party applications, computer software, tools and/or solutions to enhance the features and capabilities of the interactive business lifecycle management system. Examples of these include Security Information and Events Management, Log Management and other such tools or solutions.

The following examples demonstrate how the interactive business lifecycle management system may be deployed in real-world use.

### EXAMPLE 1

the Business Performance Visualization Solution provides business leaders with intuitive, real-time ‘at-a-glance’ views of program and process performance and operations status with an ability to drill down into specific areas of interest. This is accomplished by providing real-time measurements on key performance indicators (KPIs) and Critical Success Factors. This utilizes the basic set of components 100-120 and 160-170 of the interactive business lifecycle management system in addition to the business agility guidance module 140. However, in this case, the other components, including the business agility analytics engine 130 and the set of governance tools 150 are not included in the interactive business lifecycle management system.

### EXAMPLE 2

Business Governance Program Enablement Solution operationalizes governance and management policies for business programs. Incorporates leading industry standards, inclusive of SAS 70, SOX, HIPAA, Basel II, Cobit, ITIL, ISO, and accepts custom frameworks to assist organizations in implementing effective business controls and satisfying corporate and legislative compliance objectives. The interactive business lifecycle management system in this example employs the basic set of components 100-120 and 160-170 in addition to the other alternate components, namely, the business agility analytics engine 130, the business agility guidance module 140, and the set of governance tools 150.

At a more detailed level, the interactive business lifecycle management system includes features that are inclusive of at least the following (below) used to create individual, yet linked, business solutions. These functions may be combined within a software product platform that implements the processes and functions of the components of the interactive business lifecycle management system. Thus, multiple implementations of the interactive business lifecycle management system are possible, with at least one software product platform implementing only the basic set of components 100-120 and 160-170, and multiple other software product platforms implementing an alternate embodiments of the interactive business lifecycle management system. For example, one alternate embodiment including the basic set of components 100-120 and 160-170 along with the business agility guidance module 140, as described above in relation to Example 1, another alternate embodiment including the basic set of components 100-120 and 160-170 along with the business agility analytics engine 130, another alternate embodiment including the basic set of components 100-120 and 160-170 along with the set of governance tools 150, another alternate embodiment including the basic set of components 100-120 and 160-170 along with all the other components, the business agility analytics engine 130, the business agility guidance module 140, and the set of governance tools 150, as in Example 2 described above, etc.

Referring back to the specific features of the interactive business lifecycle management system, at least the following features are included in the interactive business lifecycle management system, whether or not each of the associated components 100-170 are maintained as single individual components, combined together to form larger components with multiple of the basic or alternate components, or split into multiple sub-components.
Analytics policy & rules grammar constructs
Probability engine
Business assets-centric analytics
Heuristics
Portfolio-centric analytics
Inference-based matching
Process metrics-based learning

Utilizing these capabilities, business solutions are enabled by developing and building one or more computer programs that integrate these functions. One example of such a business solution is demonstrated in a platform known generally as “Information DNA” (or “i*DNA” for short).

Specifically, i*DNA is a business solution that provides the ability to identify potential risks to sensitive business information assets that may affect business processes, operations, and competitiveness. An organization's sensitive business information assets consist of customer information, intellectual property, employee information, merger & acquisition plans, financial information, sales strategy, and much more. These information assets are necessary and used by business processes across the organization that relies on their availability and integrity in order to complete their operations. In some cases, these information assets are the basis for competitive differentiation and provide a market advantage. Gaining an understanding of the types of sensitive assets, their value to the organization, how they are protected, and what compliance requirements apply to the information are fundamental in order to make strategic decisions and apply appropriate controls. i*DNA delivers this capability and enables business leaders to view their sensitive information assets and risks at-a-glance. i*DNA integrates with SIEM and infrastructure governance products to map potential threats against sensitive business assets to identify critical assets at risk. i*DNA empowers business leaders by providing vital and timely information necessary to protect the organization. Utilizing rich visualization techniques, i*DNA delivers an intuitive dashboard interface depicting valuable business information assets at risk that motivates business leaders to make critical decisions.

Also, i*DNA allows managers to visualize risks to sensitive assets across departments and business functions and understand the potential impacts to the organization. This is accomplished by discovering and classifying sensitive information assets, analyzing incidents and threat vectors from SIEM-type products, analyzing reports from infrastructure governance and management products, and performing advanced analytics functions to identify sensitive assets and business processes subject to potential compromise. This ability to associate potential risks within a business context is a unique capability.

Additionally, some embodiments of the interactive business lifecycle management system may be adapted for use in other ways, outside the GRC domain, in more general management and governance domains of an organization such as in project management, program planning and management, portfolio management, program and portfolio governance, enterprise architecture design, and strategy definition, to name a few. Similarly, the interactive business lifecycle management system may be implemented as related computer software applications in light of such adapted usage, namely implementation of Project Management tools, implementation of Program and Portfolio Management tools, and implementation of Policy Management tools, etc.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

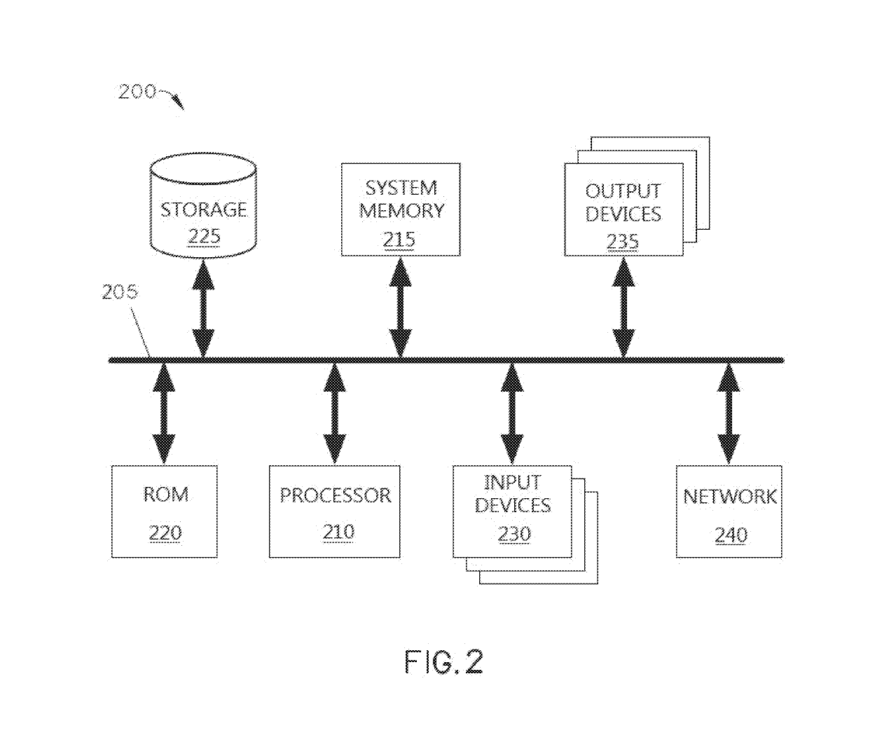

FIG. 2 conceptually illustrates an electronic system 200 with which some embodiments of the invention are implemented. The electronic system 200 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 200 includes a bus 205, processing unit(s) 210, a system memory 215, a read-only 220, a permanent storage device 225, input devices 230, output devices 235, and a network 240.

The bus 205 collectively represents all system, peripheral, and chipset buses that communicatively connect the numerous internal devices of the electronic system 200. For instance, the bus 205 communicatively connects the processing unit(s) 210 with the read-only 220, the system memory 215, and the permanent storage device 225.

From these various memory units, the processing unit(s) 210 retrieves instructions to execute and data to process in order to execute the processes of the invention. The processing unit(s) may be a single processor or a multi-core processor in different embodiments.

The read-only-memory (ROM) 220 stores static data and instructions that are needed by the processing unit(s) 210 and other modules of the electronic system. The permanent storage device 225, on the other hand, is a read-and-write memory device. This device is a non-volatile memory unit that stores instructions and data even when the electronic system 200 is off. Some embodiments of the invention use a mass-storage device (such as a magnetic or optical disk and its corresponding disk drive) as the permanent storage device 225.

Other embodiments use a removable storage device (such as a floppy disk or a flash drive) as the permanent storage device 225. Like the permanent storage device 225, the system memory 215 is a read-and-write memory device. However, unlike storage device 225, the system memory 215 is a volatile read-and-write memory, such as a random access memory. The system memory 215 stores some of the instructions and data that the processor needs at runtime. In some embodiments, the invention's processes are stored in the system memory 215, the permanent storage device 225, and/or the read-only 220. For example, the various memory units include instructions for processing appearance alterations of displayable characters in accordance with some embodiments. From these various memory units, the processing unit(s) 210 retrieves instructions to execute and data to process in order to execute the processes of some embodiments.

The bus 205 also connects to the input and output devices 230 and 235. The input devices enable the user to communicate information and select commands to the electronic system. The input devices 230 include alphanumeric keyboards and pointing devices (also called “cursor control devices”). The output devices 235 display images generated by the electronic system 200. The output devices 235 include printers and display devices, such as cathode ray tubes (CRT) or liquid crystal displays (LCD). Some embodiments include devices such as a touchscreen that functions as both input and output devices.

Finally, as shown in FIG. 2, bus 205 also couples electronic system 200 to a network 240 through a network adapter (not shown). In this manner, the computer can be a part of a network of computers (such as a local area network (“LAN”), a wide area network (“WAN”), or an Intranet), or a network of networks (such as the Internet) including personal smart mobile computing and/or communication devices such as a cell phone or a tablet computing device. Any or all components of electronic system 200 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 conceptually illustrates a block diagram of several components of an interactive business lifecycle management system that provide intuitive views of business programs, program performance, operations status, and compliance status. The interactive business lifecycle management system as a whole may be implemented as a software program which when run on a processor of a computing device carries out the steps of the processes described above by reference to FIG. 1. Alternatively, individual components of the interactive business lifecycle management system may be implemented as separate software programs which communicate and exchange data while running simultaneously on the processor of a computing device or which communicate and exchange data over a network while individually running on separate processors of separate computing devices. The specific operations of such processes may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details and examples, but rather is to be defined by the appended claims.

I claim:

1. An interactive business lifecycle management system that creates an interactive business environment visualization to control framework, compliance posture, and risk posture of a business, the interactive business lifecycle management system comprising:
a risk register data repository that stores metadata on compliance metrics, heuristics on prior compliance transactions, probability analysis, extrapolation, and other metrics needed for risk management and governance compliance;
a compliance management module that captures and displays user inputs, and retrieves, from the risk register data repository, business metrics, control definitions, and stakeholder assignments;
a business metrics module that captures the metadata related to portfolio and metrics to perform analytics and process management for compliance action items to provide intelligent and configurable metrics regarding risk and information asset portfolio;
a set of business context models comprising controls relevant to at least one of metrics, assets, business processes, and program management; and
a business governance visual dashboard that unifies visualization and management in a single console associated with the interactive business environment visualization, wherein the single console provides unification, association, and visualization of technical risks with business processes, and enables business performance visualization, business program lifecycle management, and business governance program enablement.

2. The interactive business lifecycle management system of claim 1, wherein the compliance management module includes statistical business events inference models and multi-standard frameworks that provide visibility into a compliance posture of the business in relation to relevant regulations, standards, and business objectives

3. The interactive business lifecycle management system of claim 1, wherein the risk register data repository further stores statistical risk inference models, process metrics, business-event correlation process maps, and heuristics, and includes self-learning capabilities and auto-crawling capabilities.

4. The interactive business lifecycle management system of claim 1, wherein the business governance visual dashboard amalgamates disparate processes and controls metadata from across the business, wherein said business governance visual dashboard further comprises an interface to the business metrics module for the enablement and control of the compliance management module.

5. The interactive business lifecycle management system of claim 1, wherein the business metrics module further (i) captures business metadata including details about enterprise programs, processes, assets, and stakeholders, (ii) combines disparate and distinct processes and functional components to provide unique views and analysis of business operations and risks, and (iii) analyzes and visualizes disparate and distinct processes in a unified management system.

6. The interactive business lifecycle management system of claim 1 further comprising a business agility analytics engine that provides multiple functions inclusive of a probability engine, heuristics, grammar constructs, risk patterns, risk inference models, inference-based matching, probability extrapolations, usage analysis, comprehensive “what-if” analysis, business assets centric analytics, and process based metrics learning, wherein said heuristics comprise a first set of heuristics based on past incidents and events and a second set of heuristics based on potential risk models and patterns.

7. The interactive business lifecycle management system of claim 6 further comprising a business agility guidance module comprising a patterns-based inference builder, a business impact drill-down capability, and a set of capabilities providing definition, capture, manipulation, analysis, patterns formation, dependency models, and extrapolation of matching models of governance and management constructs.

8. The interactive business lifecycle management system of claim 7, wherein the set of business context models are fundamental to one or more data feeds provided to the compliance management module and the business governance visual dashboard, wherein said data feeds comprise data associated with one or more of controls, control specifications, metrics, assets, business processes, and program management functions.

9. The interactive business lifecycle management system of claim 8, wherein the set of business context models are fundamental to the one or more data feeds provided to the business agility analytics engine and the business agility guidance module.

10. The interactive business lifecycle management system of claim 1 further comprising a set of governance tools for infusion of organizational governance processes and interconnection of distinct business processes, operations, programs, resources, and other business entities using programmatic grammar constructs for metadata elements, wherein the set of governance tools further provides statistical prioritization and dependency models, management tools and metrics, and analytics that provide insights and guidance over business processes, operations, and business programs.
